(19) United States
(12) Patent Application Publication
(10) Pub. No.: US 2026/0209138 A1
(43) Pub. Date: Jul. 23, 2026

(54) METHOD AND APPARATUS FOR PRODUCING AN ORGANIC FERTILIZER WITH REGULATION OF BACTERIAL REACTION

(71) Applicant: CIRCULUS AGTECH SOLUTIONS INC., Montreal (CA)

(72) Inventor: David LEROUX, Mont-Tremblant (CA)

(21) Appl. No.: 19/139,950

(22) PCT Filed: Dec. 14, 2023
(86) PCT No.: PCT/CA2023/051658

§ 371 Date: Jun. 17, 2025

Related U.S. Application Data
(60) Provisional application No. 63/476,269, filed on Dec. 20, 2022.

(51) Int. Cl. C05F 17/70; C05F 17/10; C05F 17/993; C05G 5/20

(52) U.S. Cl. CPC C05F 17/70; C05F 17/10; C05F 17/993; C05G 5/20

(57) ABSTRACT

There is disclosed a method of producing a fertilizer which involves mixing an organic substrate with water to initiate a bacterial reaction. The method comprises measuring in real-time a plurality of variables concerning the bacterial reaction helping to determine the bacterial change rate. The method also involves regulating the nitrate-ammonium ratio by adjusting alkalinity using an additive according to the potassium-calcium ratio and ion concentrations. Further, the method involves the regulation of the reaction by adjusting various ions concentration using respective additives to maintain ion levels on a given threshold. This results in producing an organic fertilizer with improved consistency and quality in a shorter time period compared to existing approaches. An apparatus for producing the same is also disclosed.

### BACKGROUND

### (a) Field

This disclosure relates to organic fertilizers, and more particularly to methods and apparatuses for producing organic fertilizers.

### (b) Related Prior Art

An organic fertilizer is a material that can be applied to soil or to plant tissues to supply plant nutrients. Farmers can utilize organic fertilizers to facilitate growth of crops, and hence there is considerable interest in producing organic fertilizers. Unfortunately, existing approaches for producing organic fertilizers can lead to inconsistent quality, for example inconsistent nutrients or alkalinity, especially because ingredients and recipes used to produce the organic fertilizers can vary. Also, existing approaches can be time consuming, for example taking about six months to produce an organic fertilizer due to composting time to mineralize organic nutrients and kill potential pathogens. Also, existing approaches, such as synthetic fertilizers, are produced through energy-demanding processes and have a negative environmental impact. It is desirable to improve upon the existing approaches by eliminating or mitigating some or all of the problems and disadvantages described above.

It would be highly desirable to be provided with a method for producing an organic enriched fertilizer wherein the nitrifying bacteria reaction is controlled in real time and optimized.

This invention makes use of waste-based fertilizers. Using nutrients derived from organic sources such as animal manure or agricultural residues, the final products are great fertilizers and mitigate the environmental impact of conventional fertilizer production.

### SUMMARY

Disclosed is a method of producing an organic fertilizer. The method involves mixing an organic substrate with water to initiate a bacterial reaction involving the organic substrate. The method also involves measuring, in real-time during the bacterial reaction, a plurality of variables concerning the bacterial reaction and concentrations of ions to determine a bacterial rate of change of the nitrate-ammonium ratio, wherein each variable has a defined target. The method also involves regulating a nitrate-ammonium ratio and the bacterial rate of change of the nitrate-ammonium ratio by regulating alkalinity. The method also involves regulating alkalinity by selecting an additive according to the potassium-calcium ratio and the ion concentrations and introducing the additive to the bacterial reaction. The method also involves, upon detecting that any variable of the plurality of variables has deviated from its defined target, introducing an additive into the bacterial reaction until that variable has stopped deviating from its target, thereby regulating all of the variables according to their defined targets and controlling the bacterial reaction rate. The regulating of all of the variables is executed until the bacterial reaction produces the organic fertilizer.

The regulation can result in production of an organic fertilizer with improved consistency and quality compared to existing approaches. This results in mineral forms of nutrients from an organic substrates, making the organic fertilizer directly available for plant consumption, compared to other methods of making fertilizer from organic substrates. Also, by controlling reaction rates of bacterial reactions according to methods disclosed herein, it is possible to produce organic fertilizers in a relatively short period of time, for example about two or three weeks, versus about six months with existing approaches.

In accordance with an embodiment, there is provided a real-time method of producing an enriched organic fertilizer, comprising:
mixing an organic substrate with water to initiate a bacterial reaction involving the organic substrate;
measuring, in real-time during the bacterial reaction, a plurality of variables concerning the bacterial reaction and concentrations of ions, the ions being at least some of Ca2+ (Calcium Ion), K+ (Potassium Ion), NH4+ (Ammonium), NO3− (Nitrate), HPO42− (Monohydrogen Phosphate), Mg2+ (Magnesium Ion), Cl− (Chloride Ion), and Na+ (Sodium Ion), wherein each variable and each ion concentration has a defined target;
calculating a nitrate-ammonium ratio and a bacterial rate of change of the nitrate-ammonium ratio;
calculating a potassium-calcium ratio;
regulating the nitrate-ammonium ratio and the bacterial rate of change of the nitrate-ammonium ratio by regulating alkalinity;
regulating alkalinity by selecting an additive according to the potassium-calcium ratio and the ion concentrations and introducing the additive to the bacterial reaction,
upon detecting that any variable of the plurality of variables and ion concentration has deviated from its defined target, introducing an additive into the bacterial reaction until that variable and ion concentration has stopped deviating from its target, thereby regulating all of the variables and ion concentrations according to their defined targets;
wherein the regulating of all of the variables and ion concentrations, the regulating of the nitrate-ammonium ratio and the regulating of alkalinity is executed until each variable and each ion concentration reaches its defined target, the nitrate-ammonium ratio reaches a value of between 7 to 12, and the alkalinity is in the range 50 to 300 meq/L as CaCO3,
wherein each ion concentration has a defined target of 100-2500 ppm elemental N for NO3− (Nitrate) and NH4+ (Ammonium), 30-500 ppm elemental P for HPO42− (Monohydrogen Phosphate), 100-3000 ppm for K+ (Potassium Ion), 80-1400 ppm for Ca2+ (Calcium Ion), 30-700 ppm for Mg2+ (Magnesium Ion), less than 750 ppm for Cl− (Chloride Ion).

The bacterial reaction may include a mineralization reaction in which the organic substrate is mixed with air to facilitate aerobic digestion, and a biofiltration reaction to improve nutrient availability.

The real-time method of producing an enriched organic fertilizer may comprise the step of:
upon detecting that any variable of the plurality of variables has deviated from its defined target, selecting the additive to be introduced from a plurality of candidate additives based on that variable.

The variables include pH (Potential of Hydrogen), the candidate additives comprise a set of pH-reducing additives and a set of pH-increasing additives, and the method comprises:
upon detecting that the pH is higher than its defined target, selecting the additive to be introduced from the set of pH-reducing additives as a function of the ion concentrations; and
upon detecting that the pH is lower than its defined target, selecting the additive to be introduced from the set of pH-increasing additives as a function of the ion concentrations.

The real-time method of producing an enriched organic fertilizer, may include wherein:
the set of pH-reducing additives comprise at least some of H3PO4 and H2SO4; and
the pH-increasing additives comprise at least some of KOH, Ca(OH)2, Mg(OH)2, CaCO3, K2CO3.

The real-time method of producing an enriched organic fertilizer, may include wherein:
selecting the additive to be introduced from the set of pH-reducing additives as a function of the ion concentrations comprises selecting a first pH-reducing additive from the set of pH-reducing additives and selecting a second pH-reducing additive from the set of pH-reducing additives upon detecting that the first pH-reducing additive causes deviation of one of the ion concentrations from its defined target; and
selecting the additive to be introduced from the set of pH-increasing additives as a function of the ion concentrations comprises selecting a first pH-increasing additive from the set of pH-increasing additives and selecting a second pH-increasing additive from the set of pH-increasing additives upon detecting that the first pH-increasing additive causes deviation of one of the ion concentrations from its defined target.

The defined target for the pH is a target range, which may vary depending on a stage of the bacterial reaction, or wherein the target range for each ion concentration is constant during the bacterial reaction.

The set of alkalinity-increasing additives may comprise at least some of Ca(OH)2, NaOH, Na2CO3, NaHCO3, Mg(OH)2, Mg(HCO3)2.

The selecting the additive to be introduced from the set of alkalinity-increasing additives according to the potassium-calcium ratio and the ion concentrations may comprise selecting a first alkalinity-increasing additive from the set of alkalinity-increasing additives and selecting a second alkalinity-increasing additive from the set of alkalinity-increasing additives upon detecting that the first alkalinity-increasing additive causes deviation of one of the ion concentrations from its defined target.

The variables may further comprise ec (electrical conductivity) and temperature.

The real-time method of producing an enriched organic fertilizer, may further comprise:
upon producing the organic fertilizer, measuring additional variables to confirm quality control.

In accordance with an embodiment, there is provided an organic fertilizer produced using real-time method of producing an enriched organic fertilizer.

The organic fertilizer may be in a liquid form.

In accordance with an embodiment, there is provided the use of the organic liquid fertilizer in soilless cultures.

In accordance with an embodiment, there is provided a monitoring apparatus for use in producing an organic fertilizer, the monitoring apparatus comprising:
an analyzer having (1) a plurality of probes configured to measure in real-time a plurality of variables concerning a bacterial reaction involving aerobic digestion of an organic substrate that has been mixed with water and concentrations of ions, and (2) a plurality of liquid transfer ports configured to introduce liquids into the bacterial reaction; and
a dosing unit and interface coupled to the analyzer and configured to, upon detecting that any variable of the plurality of variables or any ion has deviated from a defined target, introduce an additive into the bacterial reaction via the liquid transfer ports until that variable has stopped deviating from its target, thereby regulating all of the variables according to their defined targets until the bacterial reaction produces the organic fertilizer.

The plurality of probes may comprise at least some of a pH (Potential of Hydrogen) probe, a Ca2+ (Calcium Ion) probe, a K+ (Potassium Ion) probe, an NH4+ (Ammonium) probe, an NO3− (Nitrate) probe, and EC (Electrical Conductivity) probe, and a temperature probe.

In accordance with an embodiment, there is provided an organic fertilizer produced using the monitoring apparatus.

In accordance with an embodiment, there is provided a non-transitory computer readable medium having recorded thereon statements and instructions that, when executed by a processor of an apparatus, configure the processor to implement a method comprising a step or any combination of steps as described and/or depicted herein.

In accordance with another embodiment, upon detecting that any variable of the plurality of variables has deviated from its defined target, the additive to be introduced is selected from a plurality of candidate additives based on that variable. In accordance with another embodiment, the variables include pH (Potential of Hydrogen), and the candidate additives include a set of pH-reducing additives and a set of pH-increasing additives. Upon detecting that the pH is higher than its defined target, the additive to be introduced is selected from the set of pH-reducing additives as a function of the potassium-calcium ratio and the ion concentrations. Conversely, upon detecting that the pH is lower than its defined target, the additive to be introduced is selected from the set of pH-increasing additives as a function of the ion concentrations. By regulating the pH as well as the ion concentrations throughout the bacterial reaction, the benefits noted above for the regulation may be achieved.

Also disclosed is an apparatus configured to produce an organic fertilizer. The apparatus has an analyzer having a plurality of probes configured to measure in real-time a plurality of variables concerning a bacterial reaction involving aerobic digestion of an organic substrate that has been mixed with water and concentrations of ions. The analyzer also has a plurality of liquid transfer ports configured to introduce liquids into the bacterial reaction. The apparatus also has a dosing unit and interface coupled to the analyzer and configured to, upon detecting that any variable of the plurality of variables has deviated from a defined target, introduce an additive into the bacterial reaction via the liquid transfer ports until that variable has stopped deviating from its target, thereby regulating all of the variables according to their defined targets until the bacterial reaction produces the organic fertilizer. Thus, the benefits noted above for the regulation may be achieved.

Also disclosed is an organic fertilizer produced using a method as summarized above and/or an apparatus as summarized above. The organic fertilizer may have improved consistency and quality compared to fertilizers produced using existing approaches, and may be produced in shorter time periods.

Also disclosed is the use of the method to produce an organic liquid fertilizer for use in soilless cultures.

### BRIEF DESCRIPTION OF THE DRAWINGS

Further features and advantages of the present disclosure will become apparent from the following detailed description, taken in combination with the appended drawings, in which:

FIG. 1 shows a block diagram of an organic fertilizer producing apparatus;

FIG. 2 shows a flowchart of a method of producing an organic fertilizer;

FIG. 3 shows an example monitoring apparatus having an analyzer, a dosing unit, and an interface unit;

FIGS. 4A to 4F show example features of the analyzer shown in FIG. 3 such as probes and liquid transfer ports;

FIGS. 5A to 51 are photographs and schematics showing example features of a combined dosing and interface unit;

FIGS. 5J to 5L are schematics showing the analyzer and the combined dosing and interface unit;

FIG. 6 shows a wiring diagram for the example combined dosing and interface unit;

FIG. 7 shows a flowchart of another method of producing an organic fertilizer;

FIG. 8 is a schematic of another fertilizer producing apparatus;

FIGS. 9A to 9F are schematics of another example fertilizer producing apparatus; and

FIGS. 10A and 10B show a flowchart of another example method of producing an organic fertilizer.

FIG. 11 shows the average produced ground fresh mass of a basil plant treated with a liquid fertilizer based on Frass, the manure of tenebrion beetles, that is produced by the present method, with different concentrations of calcium nitrate, trace elements and iron.

FIG. 12 shows the average height of a basil plant treated with a liquid fertilizer based on Frass, the manure of tenebrion beetles, that is produced by the present method, with different concentrations of calcium nitrate, trace elements and iron.

FIGS. 13A to 13D are photographs of basil plants show the basil plants treated with a liquid fertilizer based on Frass, the manure of tenebrion beetles, that is produced by the present method, with different concentrations of calcium nitrate, trace elements and iron.

FIG. 14 is a photograph of peppers produced from plants treated with a liquid fertilizer based on Frass, the manure of tenebrion beetles, that is produced by the present method, with different concentrations of calcium nitrate, trace elements and iron.

FIG. 15A to 15B are photographs of peppers plants treated with a liquid fertilizer based on Frass, the manure of tenebrion beetles, that is produced by the present method, with different concentrations of calcium nitrate, trace elements and iron.

FIG. 16 shows the evolution of nitrogen form monitoring using the present method.

FIG. 17 shows raw data ion monitoring using the present method.

FIG. 18 is a picture of the ion monitoring apparatus of the present invention.

FIG. 19 shows that supplies nitrogen in nitrate form and at rates similar to inorganic fertilizers when comparing the average initial N content (mg/L) of three different solutions: 1) Inorganic: Hoagland solution, 2) OLF: an organic liquid fertilizer (OLF) produced by the present invention, 3) OLF+: 50:50 proportional mix.

FIG. 20 shows that there is no difference in yield and development when comparing the average aboveground biomass (g), height (cm) and root length (cm) of basil plants (n=45) fertilized with three different solutions 1) Inorganic: Hoagland solution, 2) OLF: an organic liquid fertilizer (OLF) produced by the present method, 3) OLF+: 50:50 proportional mix. NS indicates a non-significant effect (p>0.05).

FIG. 21 shows pictures of mature plants at harvest, being fertilized with three different solutions 1) Inorganic: Hoagland solution, 2) OLF: an organic liquid fertilizer produced by the present method, 3) OLF+: 50:50 proportional mix.

FIG. 22 shows higher nitrogen use efficiency in plants fertilized with organic liquid fertilizer produced by the present invention by showing Average PFP score of beds (n=3) fertilized with three different solutions: 1) Inorganic: Hoagland solution, 2) OLF: organic liquid fertilizer (OLF) produced by the current method, 3) OLF+: 50:50 proportional mix. NS indicates a non-significant effect (p>0.05).

### DETAILED DESCRIPTION

It should be understood at the outset that although illustrative implementations of one or more embodiments of the present disclosure are provided below, the disclosed systems and/or methods may be implemented using any number of techniques. The disclosure should in no way be limited to the illustrative implementations, drawings, and techniques illustrated below, including the exemplary designs and implementations illustrated and described herein, but may be modified within the scope of the appended claims along with their full scope of equivalents.

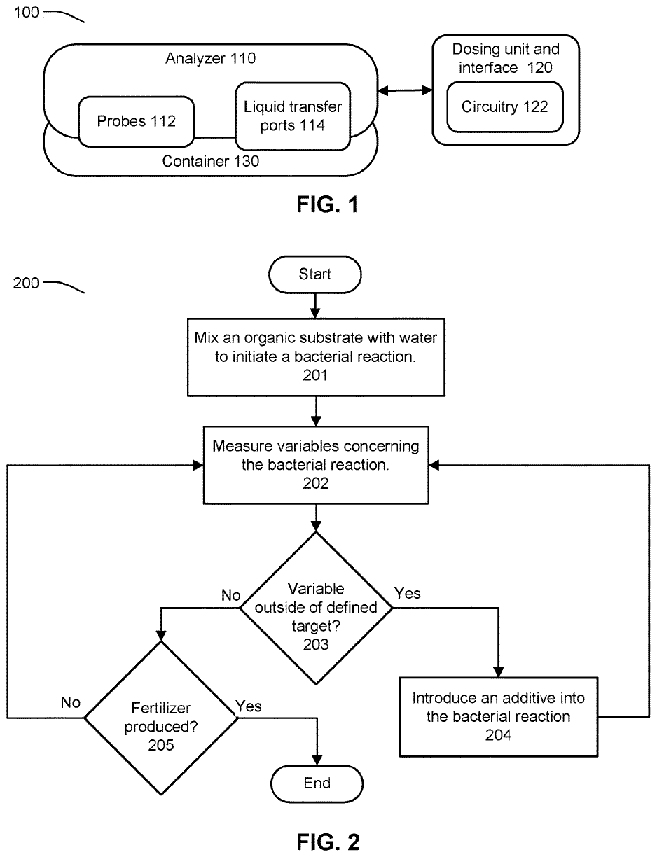

Referring first to FIG. 1, shown is a block diagram of an apparatus 100 configured to produce an organic fertilizer. The apparatus 100 has an analyzer 110 having probes 112 and liquid transfer ports 114. The apparatus 100 also has a dosing unit and interface 120 coupled to the analyzer 110, which has circuitry 122. In some implementations, the apparatus 100 also has a container 130. The apparatus 100 may have other components that are not specifically shown.

Operation of the apparatus 100 will be described below with reference to FIG. 2, which is a flowchart of a method 200 of producing an organic fertilizer. Although the method 200 of FIG. 2 is described below with reference to the apparatus 100 of FIG. 1, it is to be understood that the method 200 of FIG. 2 is applicable to other fertilizer producing apparatuses and other monitoring apparatuses for use in fertilizer production. In general, the method 200 of FIG. 2 is applicable to any appropriately configured apparatus.

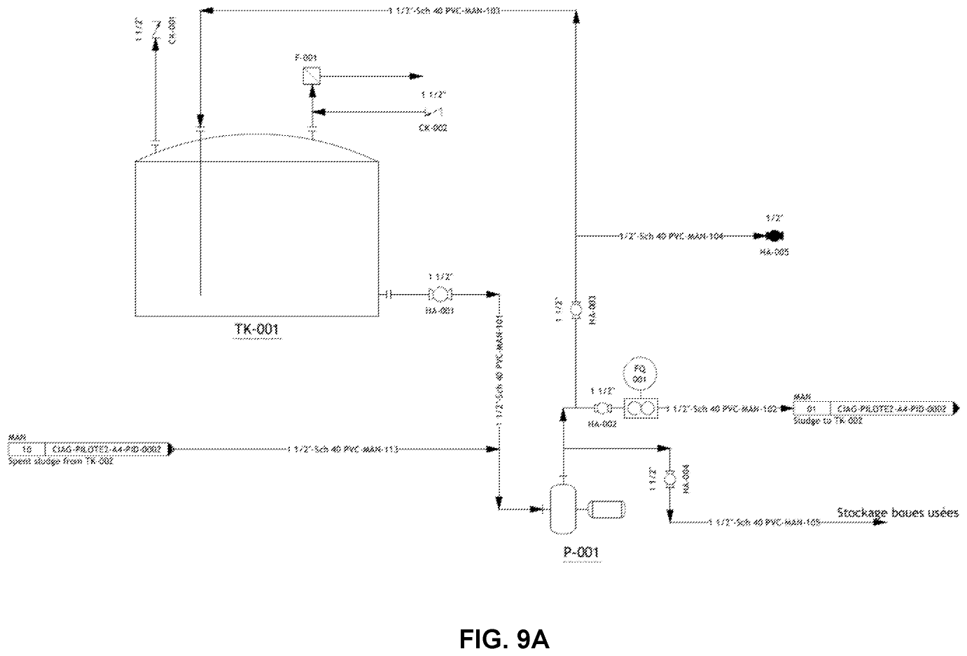

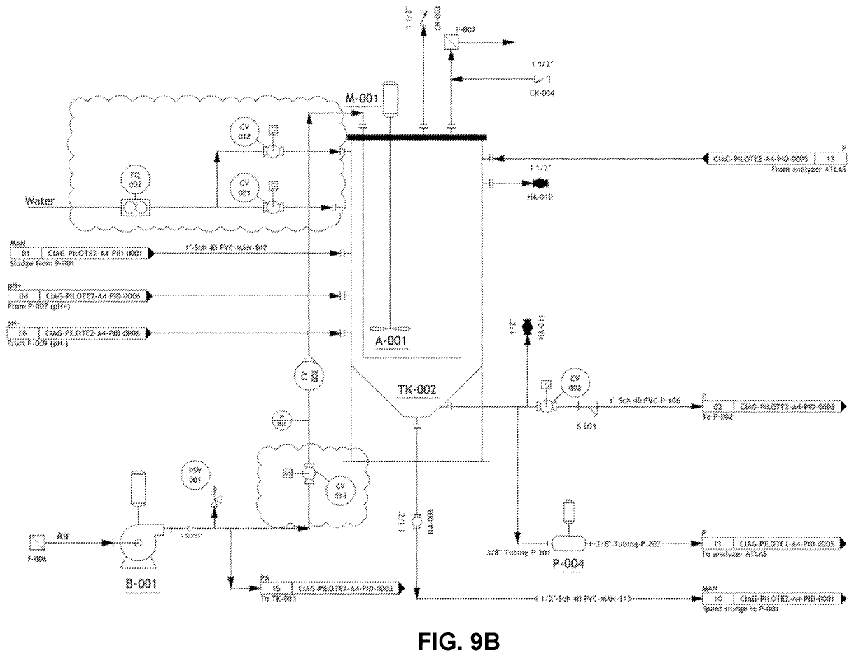

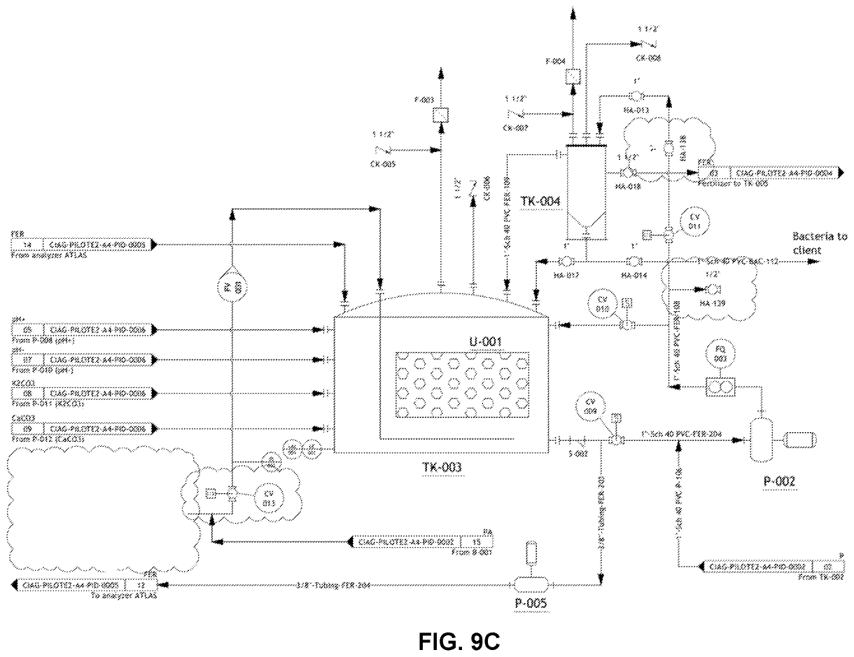

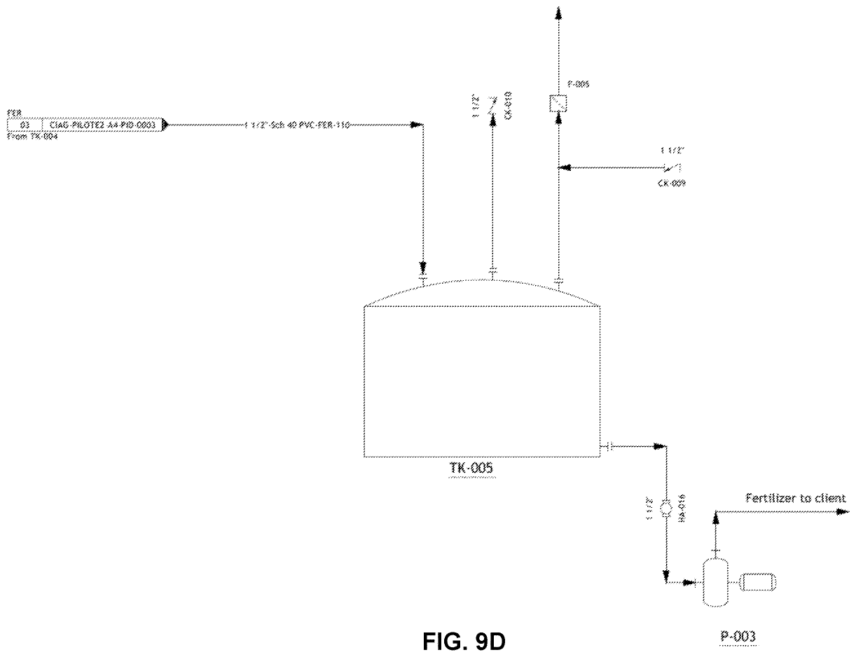

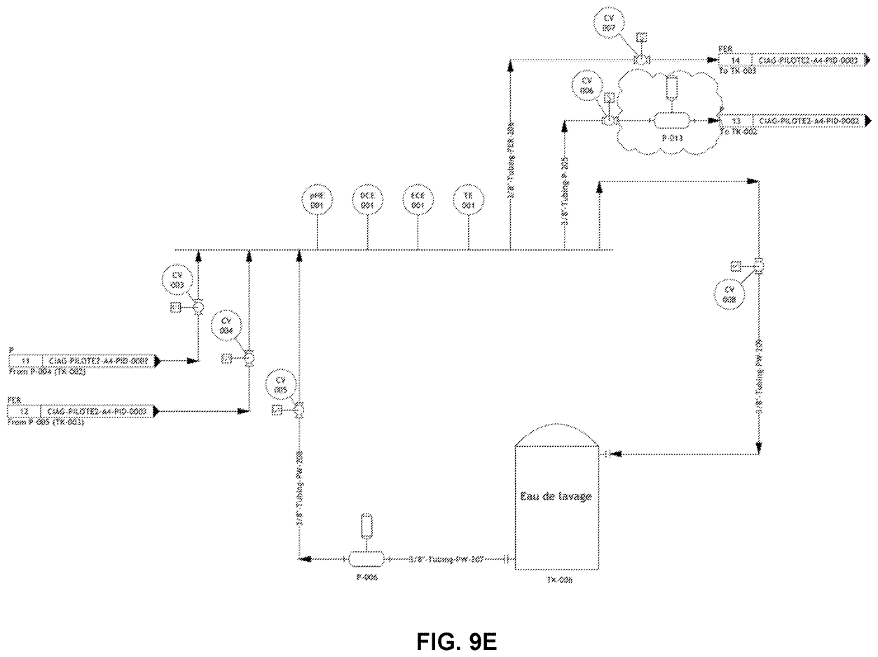

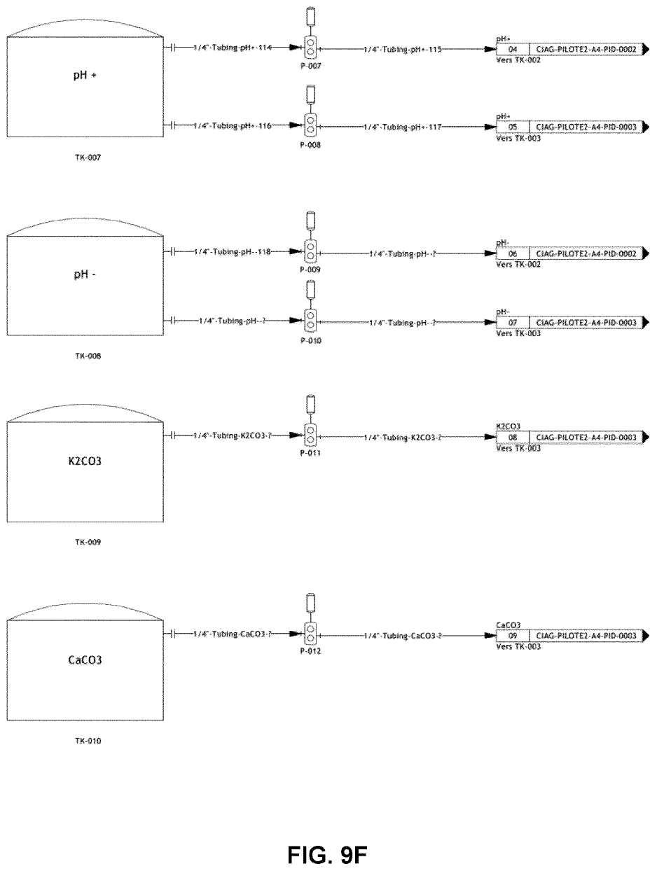

At step 201, the method begins with mixing an organic substrate with water to initiate a bacterial reaction involving the organic substrate. Such mixing can for example be performed in the container 130 of the apparatus 100, or in any other suitable location or setting, such as the example system shown in FIGS. 9A to 9F. In some implementations, the bacterial reaction involves aerobic digestion. With aerobic digestion, it is possible to mineralize nutrients, kill pathogens, and remove odors. In some implementations, the bacterial reaction includes a mineralization reaction in which the organic substrate is mixed with air to facilitate aerobic digestion, and then a biofiltration reaction to improve nutrient availability. In some implementations, the container 130 of the apparatus 100 includes a first container for the mineralization reaction, and a second container for the biofiltration reaction, although other implementations are possible in which the container 130 is a single container for both the mineralization reaction and the biofiltration reaction. Note that the mineralization reaction and the biofiltration reaction are example reactions. More generally, the bacterial reaction can include one or more reactions based on the organic substrate.

At step 202, the method involves the apparatus 110 measuring, in real-time during the bacterial reaction, a plurality of variables concerning the bacterial reaction and concentrations of ions. Ions can be monitored at multiple stages of the bacterial reaction (e.g. mineralization reaction and biofiltration reaction). In some implementations, for each variable, the analyzer 110 has a corresponding probe 112 for measuring that variable. Note that each variable and ion concentration has a defined target (e.g. target range). It is intended for each variable to be regulated throughout the bacterial reaction to control the bacterial reaction rate. This can include multiple stages of the bacterial reaction, for example the mineralization reaction and biofiltration reaction.

At step 203, upon the apparatus 100 detecting that any variable of the plurality of variables or any ion concentration has deviated from its defined target, then at step 204 the apparatus 100 introduces an additive into the bacterial reaction until that variable has stopped deviating from its target. For example, the circuitry 122 of the dosing unit and interface 120 can determine which additive to introduce based on measurements by the probes 112 of the analyzer, and the additive that has been selected can be introduced via the liquid transfer ports 114 of the analyzer 110.

Note that step 204 can be repeated until at step 203 none of the variables and ion concentrations are outside of their defined targets. In this manner, all of the variables and ion concentrations can be regulated according to their defined targets until at step 205 the organic fertilizer is produced. This can result in production of an organic fertilizer with improved consistency and quality compared to existing approaches. Also, the regulating can be performed to improve a rate of the bacterial reaction, thereby making it possible to produce the organic fertilizer in a relatively short period of time, for example about two or three weeks, versus about six months with existing approaches.

In some implementations, upon detecting that any variable of the plurality of variables or any ion concentration has deviated from its defined target, the additive to be introduced is selected from a plurality of candidate additives based on that variable. Note that there can be several different candidate additives to choose from, and the selection can depend on the variable that has deviated, and possibly other factors as well such as ion concentrations for example. The circuitry 122 of the dosing unit and interface 120 can select which additive to be introduced.

There are many possibilities for the variables concerning the bacterial reaction. In some implementations, the variables include pH (Potential of Hydrogen), and the candidate additives include a set of pH-reducing additives and a set of pH-increasing additives. Upon detecting that the pH is higher than its defined target, the additive to be introduced is selected from the set of pH-reducing additives as a function of the ion concentrations. Conversely, upon detecting that the pH is lower than its defined target, the additive to be introduced is selected from the set of pH-increasing additives as a function of the ion concentrations. Other implementations are possible.

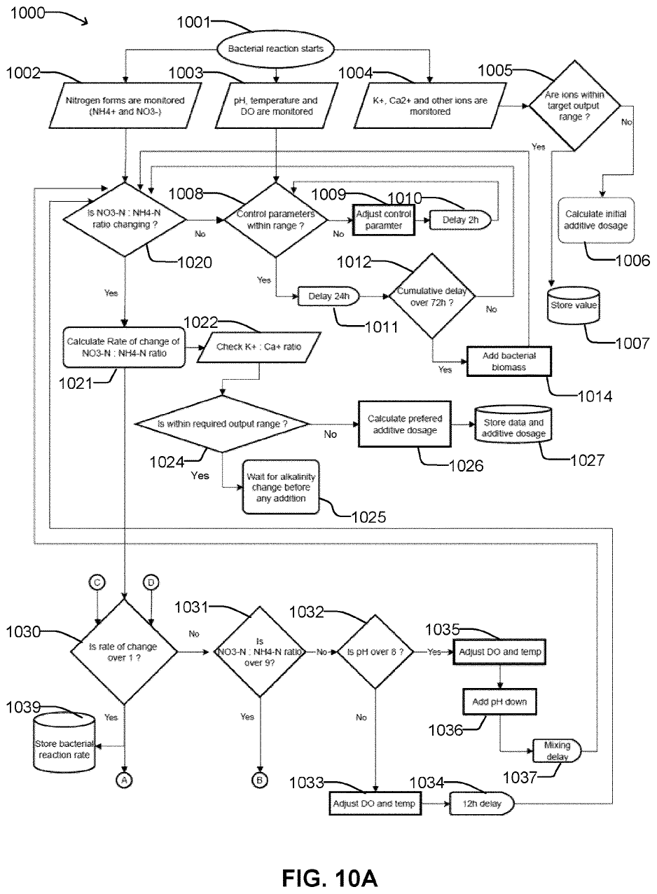

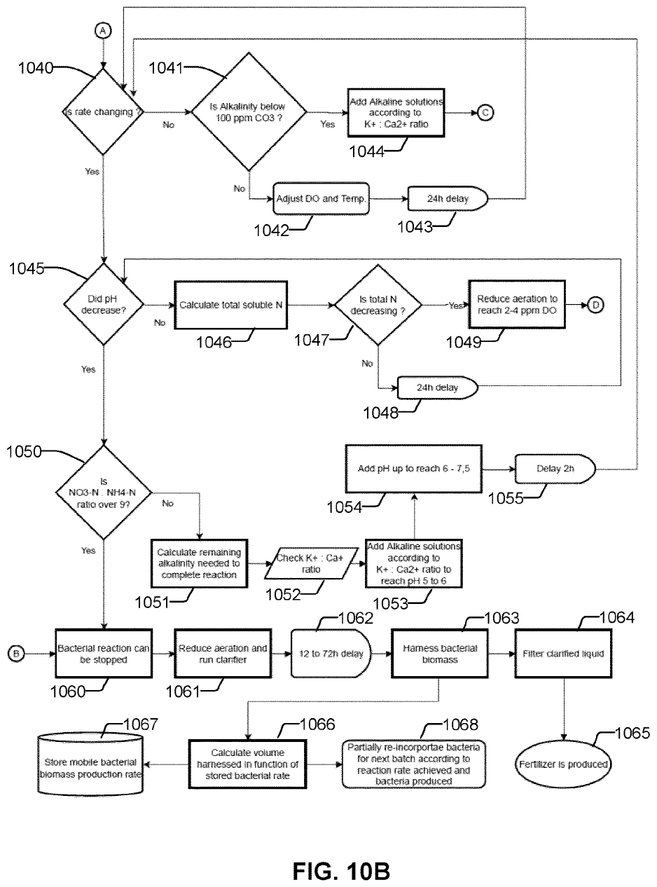

In some implementations, a reaction rate of the bacterial reaction is monitored, and additive(s) are selected to be introduced to control the reaction rate. The additive can be selected with a view to increasing or maintaining the reaction rate, such that the bacterial reaction can be completed in an expedited manner. For example, FIG. 10A and 10B show an example method 1000 wherein a nitrate-ammonium ratio and changes thereto are determined determined and used, along with other variables, to adjust reaction conditions to optimize the bacterial reaction rate, as discussed further below.

There are many possibilities for the set of pH-reducing additives and the pH-increasing additives. In specific implementations, the set of pH-reducing additives includes at least some of H₃PO₄ and H₂SO₄. In specific implementations, the pH-increasing additives comprise at least some of KOH, Ca(OH)₂, Mg(OH)₂, CaCO₃, K₂CO₃. Other implementations are possible.

There are many possibilities for the ion concentrations being monitored. In specific implementations, the ion concentrations include at least some of Ca²⁺ (Calcium Ion), K⁺ (Potassium Ion), NH₄⁺ (Ammonium), NO₃₋ (Nitrate), HPO₄²⁻ (Monohydrogen Phosphate), Mg²⁺ (Magnesium Ion), Cl⁻ (Chloride Ion), and Na⁺ (Sodium Ion). Other implementations are possible.

In some implementations, when step 204 is being repeated to reduce or increase the pH, more than one additive is introduced. For example, the apparatus 100 might select a first pH-reducing additive and then select a second pH-reducing additive upon detecting that the first pH-reducing additive is causing deviation of one of the ion concentrations from its defined target. The second pH-reducing additive can replace (or supplement) use of the first pH-reducing additive. Conversely, when step 204 is being repeated to increase the pH, more than one additive can be introduced. The selection of the additive is dynamic, such that each time step 204 is repeated, it is possible that a different additive is selected.

In some implementations, the defined target for the pH is a target range. In some implementations, the target range for the pH varies depending on a stage of the bacterial reaction. The target range can for example be between 3 and 10. Note that pH can vary greatly depending on input. Other implementations are possible.

In some implementations, the defined target for each ion concentration is a target range. In some implementations, the target range for each ion concentration is constant during the bacterial reaction. In some implementations, the target range for each ion concentration is specific to the ion concentration. Specific example target ranges for the ion concentrations are listed below, although it is to be understood that other implementations are possible.
Nitrogen, form of Nitrate (NO₃), Ammonium (NH₄⁺): 100-2500 ppm elemental N
Phosphorus, form of Dihydrogen phosphate (H₂PO₄₋) Phosphate (PO₄³⁻) Monohydrogen phosphate (HPO₄²⁻): 30-500 ppm elemental P
Potassium (K⁺): 100-3000 ppm
Calcium (Ca₂₊): 80-1400 ppm
Magnesium (Mg₂₊): 30-700 ppm
Chloride (Cl): less than 750 ppm
Sodium (Na⁺): less than 500 ppm

In some implementations, the variables measured by the apparatus 100 also includes EC (Electrical Conductivity). EC can be a good indicator of mineralization of the organic substrate. EC of a liquid fraction of the mineralization reaction will increase until it reaches a plateau, at which the liquid will be transferred to the biofiltration reaction. It is noted that EC can vary significantly, depending on working substrates and recipes, but generally it does not reach a maximum working value. In some implementations, EC and monitored ions are used to forecast other ionic concentrations using statistical models such as learning trees. Other ions can be monitored for quality control and database building according to input supply.

In some implementations, the variables measured by the apparatus 100 also includes temperature, which can be used to ensure a preferred operation temperature for bacteria to thrive. Temperature can be controlled by a heating/cooling jacket on a container within which the bacterial reaction is occurring, one or more heat exchangers, or other means.

In some implementations, upon producing the organic fertilizer, the apparatus 100 measures additional variables to confirm quality control. Such additional variables might not be measured in real-time, unlike the variables that are measured at step 202. Specific example target ranges are listed below for the additional variables, although it is to be understood that other implementations are possible.
Sulfur, form of Sulfate (SO₄²⁻): 50-1200 ppm elemental S
Iron, form of Ferrous ion (Fe²⁺), Ferric ion (Fe³⁺): 1-50 ppm
Copper (Cu²⁺): 0.04-2 ppm
Manganese (Mn²⁺): 0.5-10 ppm
Zinc (Zn²⁺): 0.3-6 ppm
Molybdenum, form of Molybdate (MoO₄²⁻): 0.04-0.8 ppm
Boron, form of Boric acid (H₃BO₃), Borate (H₂BO₃₋): 0.2-5 ppm elemental B

As part of quality control, other parameters that can be monitored can include BOD (Biological Oxygen Demand), COD (Chemical Oxygen Demand), and alkalinity. In some implementations, alkalinity change is a major parameter to monitor and control during the process to control the bacterial reaction rate. In some implementations, alkalinity change is also used for quality control.

There are many possibilities for the circuitry 122 of the apparatus 100 of FIG. 1. In some implementations, the circuitry 122 includes a processor such as a microcontroller or a CPU (Central Processing Unit) capable of executing software and/or firmware. Other implementations are possible and are within the scope of this disclosure. It is noted that other implementations can include additional or alternative hardware components, such as any appropriately configured FPGA (Field-Programmable Gate Array) or ASIC (Application-Specific Integrated Circuit), for example.

According to an embodiment of the disclosure, there is provided a non-transitory computer readable medium having recorded thereon statements and instructions that, when executed by a processor, implement a method as described herein. The non-transitory computer readable medium can be a computer readable medium of the apparatus 100 shown in FIG. 1, or some other non-transitory computer readable medium. The non-transitory computer readable medium can for example include an SSD (Solid State Drive), a hard disk drive, a CD (Compact Disc), a DVD (Digital Video Disc), a BD (Blu-ray Disc), a memory stick, or any appropriate combination thereof.

Also disclosed is an organic fertilizer produced using the method of FIG. 2 and/or the apparatus 100 of FIG. 1. The organic fertilizer may have improved consistency and quality compared to fertilizers produced using existing approaches. Also, the regulating can be performed to improve a rate of the bacterial reaction, thereby making it possible to produce the organic fertilizer in a relatively short period of time, for example about two or three weeks, versus about six months with existing approaches.

Example Implementation Details Further example implementation details are provided in this section. It is to be understood that these implementation details are very specific and are provided merely for exemplary purposes.

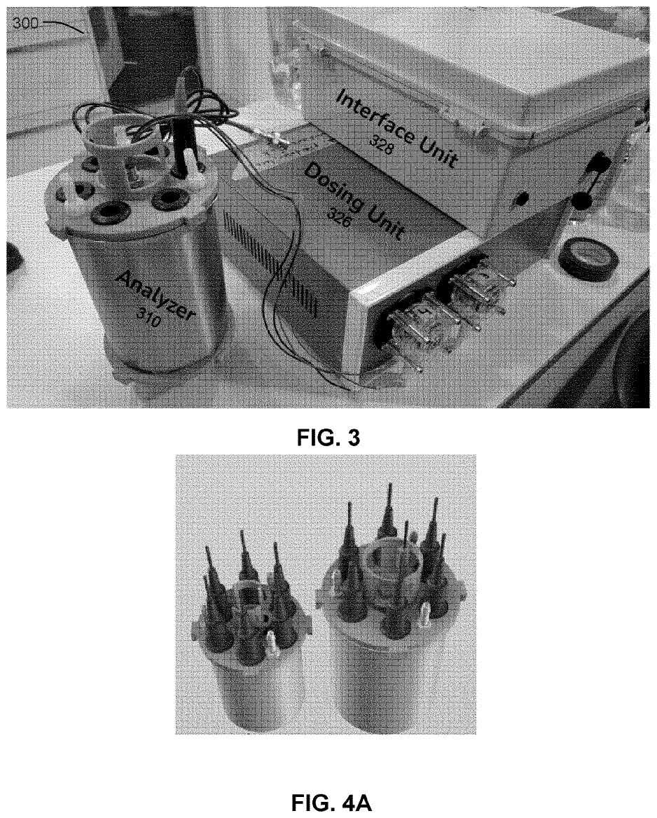

Referring now to FIG. 3, shown is a schematic of a monitoring apparatus 300 having an analyzer 310, a dosing unit 326, and an interface unit 328. The monitoring apparatus 300 can be used as part of a manufacturing system to produce an organic fertilizer. Note that the dosing unit 326 and the interface unit 328 are shown as separate components. However, other implementations are possible in which the dosing unit 326 and the interface unit 328 are combined together.

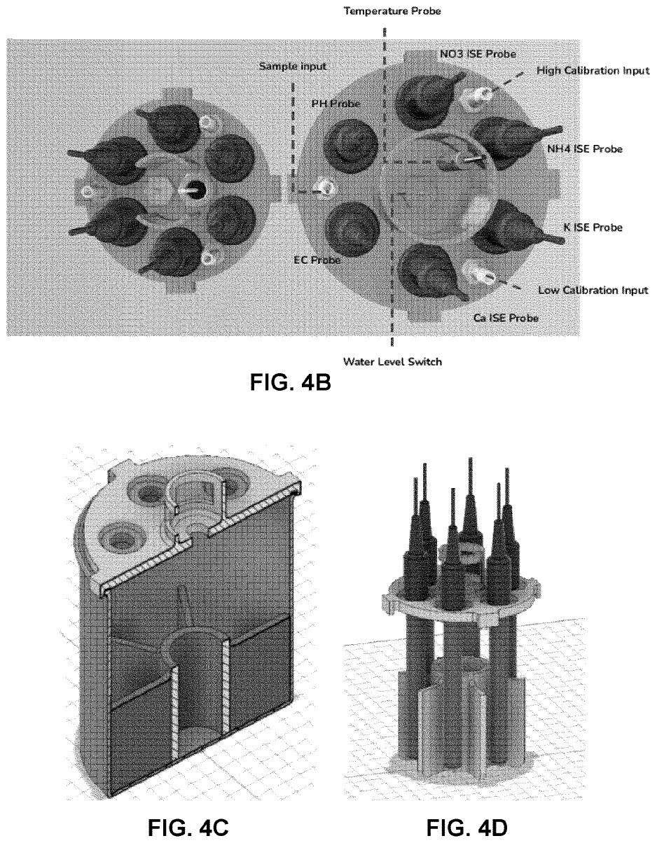

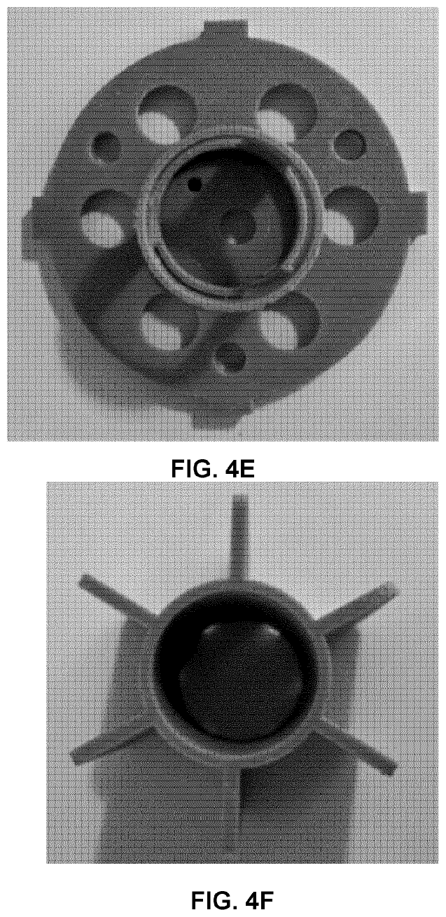

Referring now to FIGS. 4A to 4F, shown are example features of the analyzer 310 shown in FIG. 3, including a plurality of probes and liquid transfer ports. In some implementations, the probes may be Cole-Parmer probes and can be used for monitoring HPO₄²− (Hydrogen Phosphate), Mg²+ (Magnesium), Cl⁻ (Chloride) and Na⁺ (Sodium). In some implementations, the Cole-Parmer probe has a membrane formed of a polymer, a body formed of glass, and a connector that is BNC (Bayonet Neill-Concelman). In other implementations, other types of probes may be used, such as Vernier probes or other probes. The analyzer may be configured for particular types of probes of different sizes, as shown for example in FIG. 4A which shows two differently sized analyzer configured to accommodate differently sized probes.

In some implementations, the analyzer 310 has vessel modifications for input & output (multi input ports, one output port with pump attachment, fittings for modifications to attach inputs and outputs). In some implementations, the analyzer 310 comprises a lid portion (an example of which is shown in isolation FIG. 4E) configured to fit over the lip of a cylindrical analysis vessel and having a plurality of apertures for receiving probes, liquid transfer ports, and sensor ports, and vessel insert (an example of which is shown in isolation FIG. 4F) having a plurality of baffles positioned between the probes for reducing interference between probes.

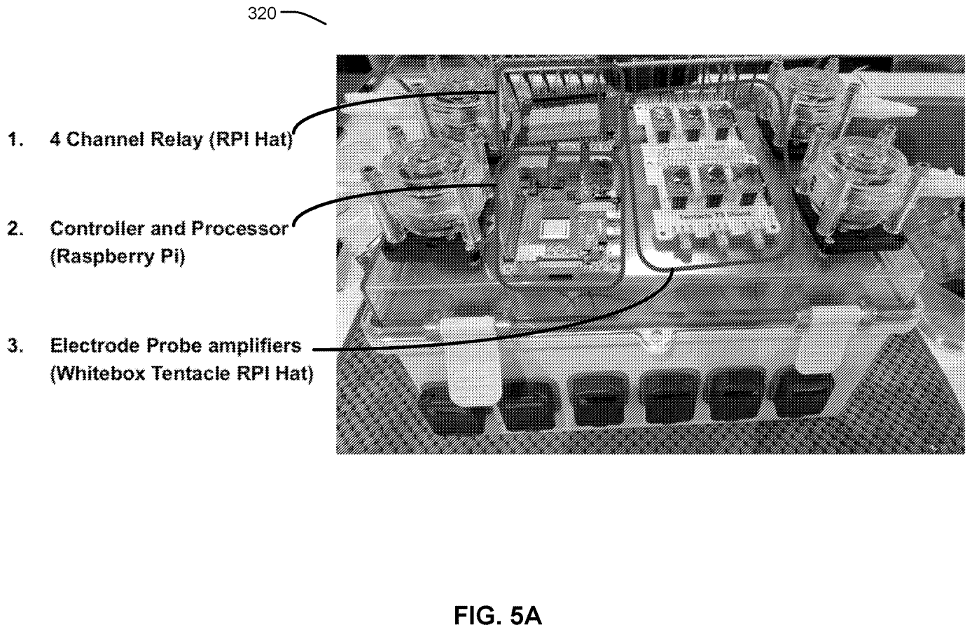

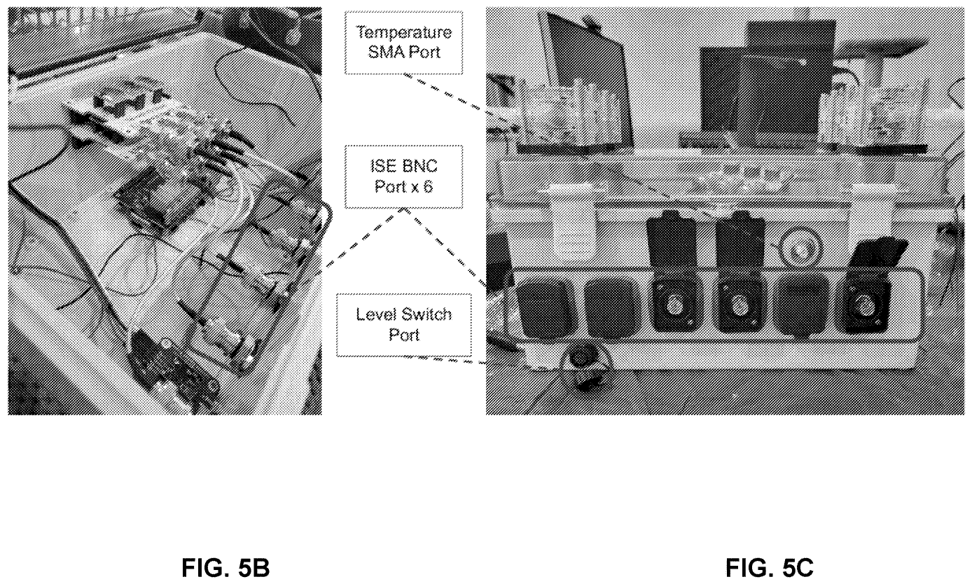

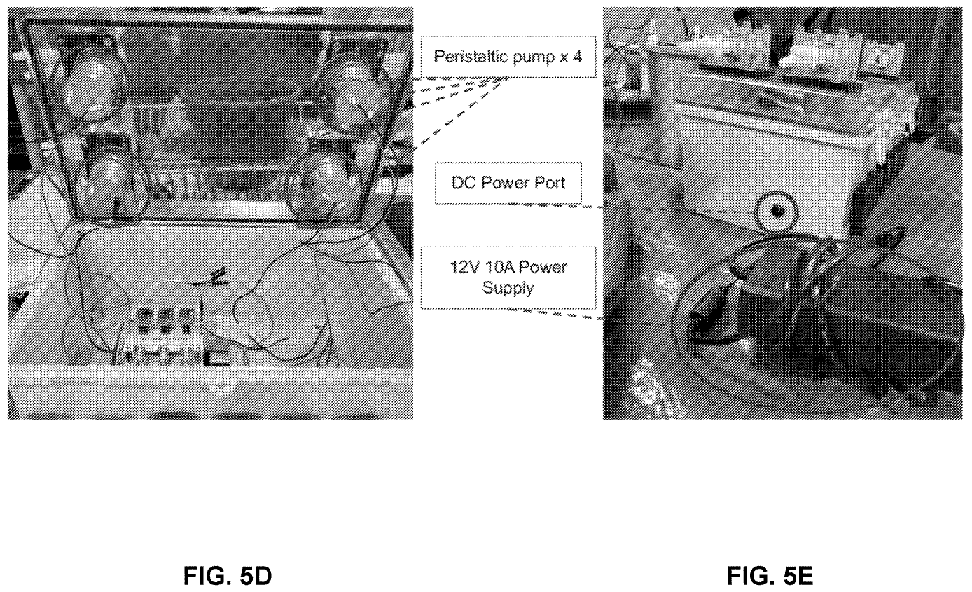

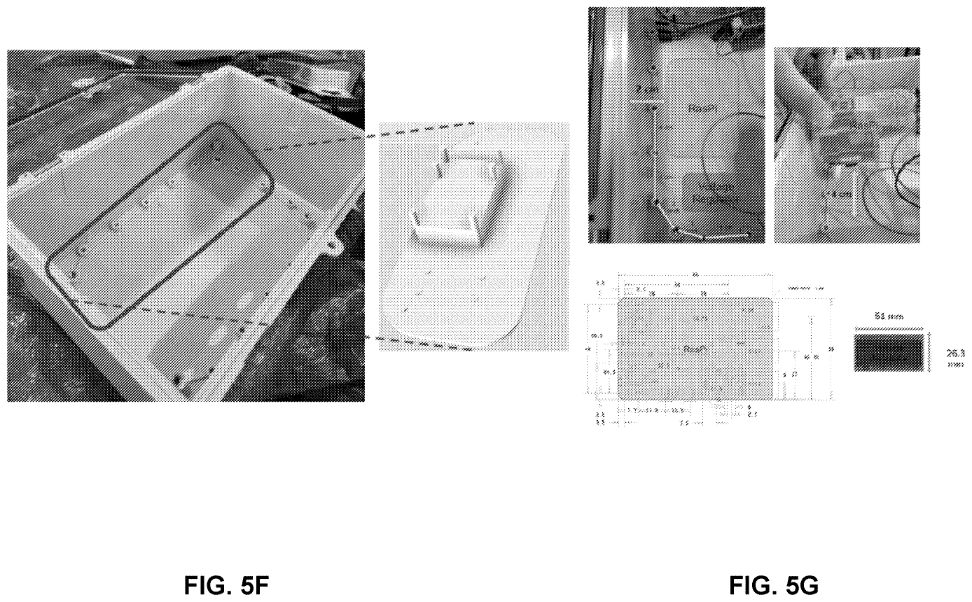

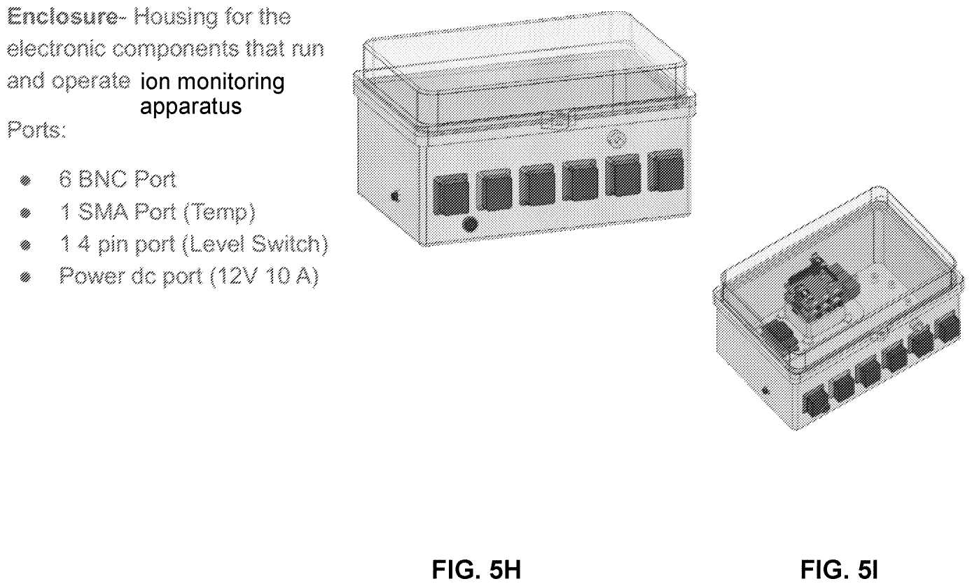

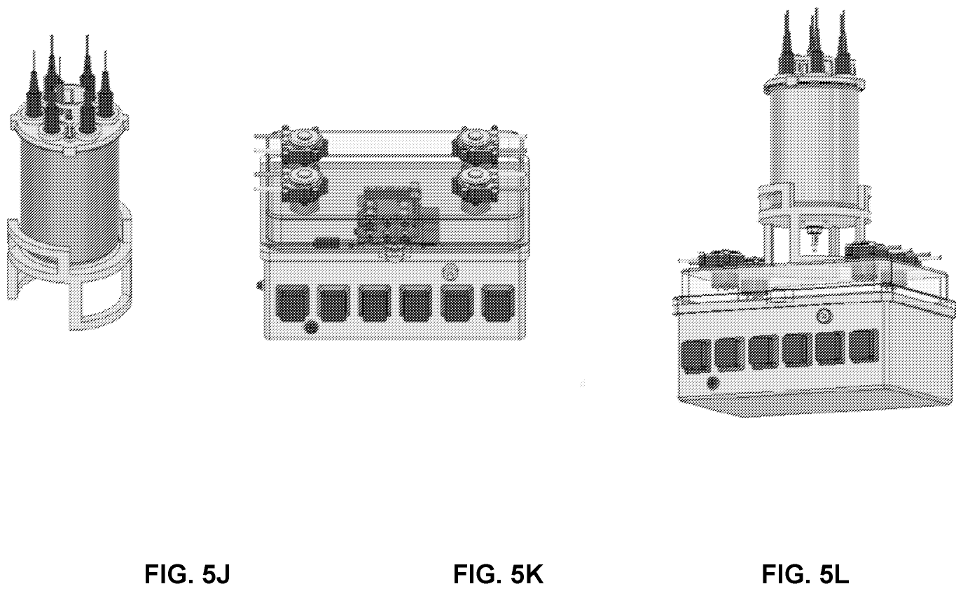

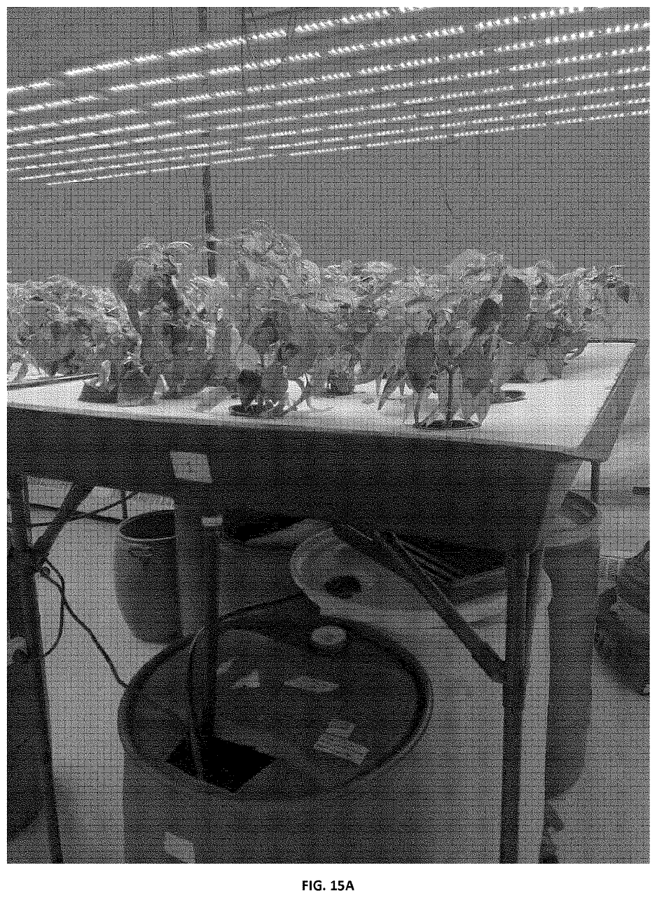

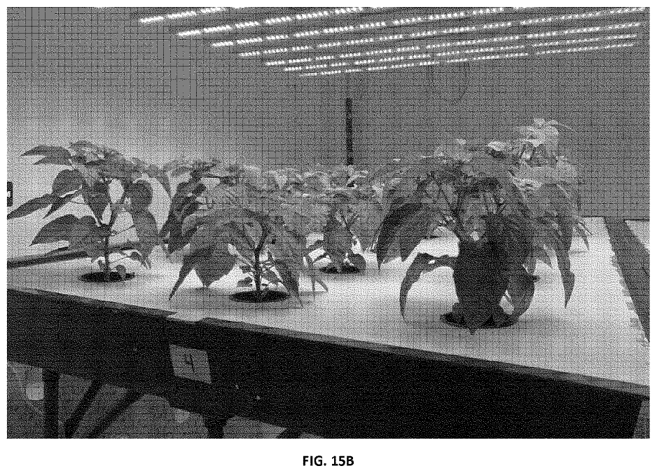

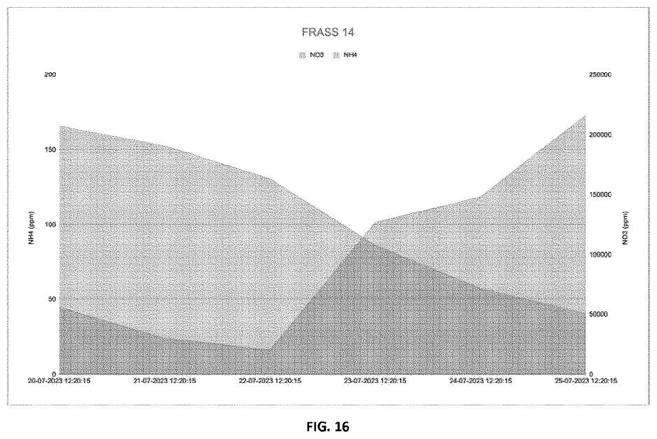

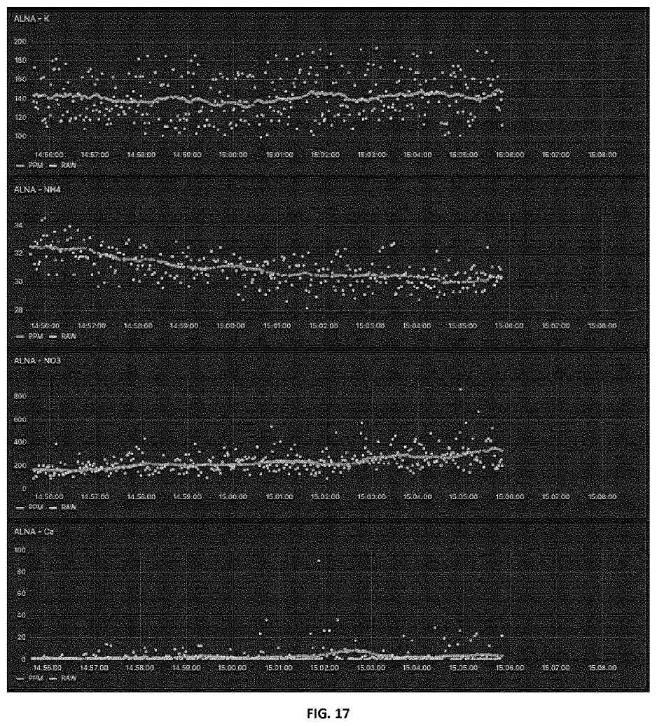

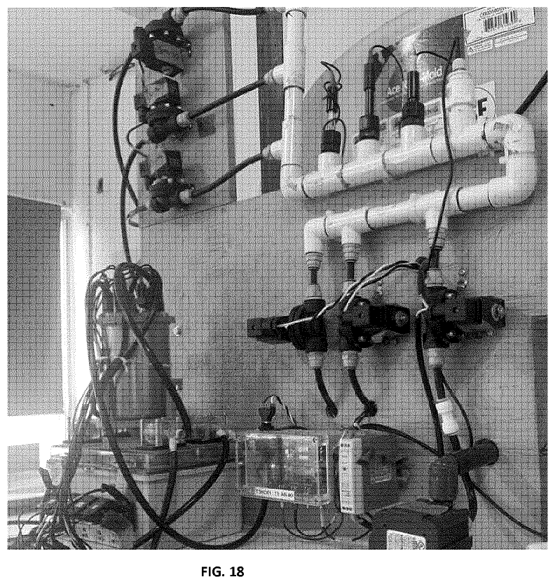

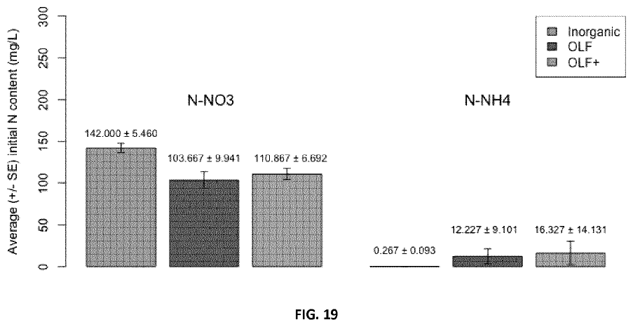

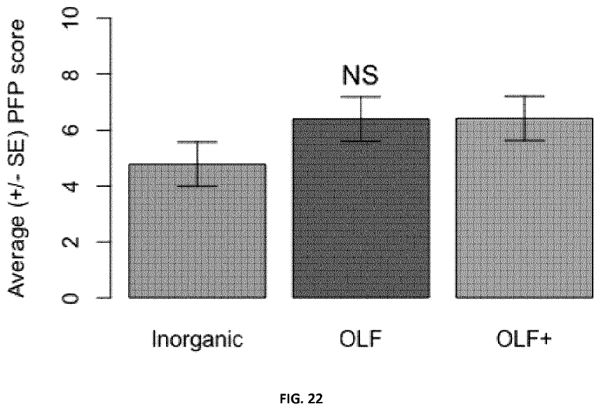

Referring now to FIGS. 5A to 51, shown are schematics showing example features of a combined dosing and interface unit 320. The combined dosing and interface unit 320 shown in FIGS. 5A to 51 implements functionality similar to the dosing unit 326 and the interface unit 328 shown in FIG. 3.

Referring now to FIGS. 5J to 5L, shown are schematics showing the analyzer 310 and the combined dosing and interface unit 320, including a stand for mounting the analyzer on the combined dosing and interface unit.

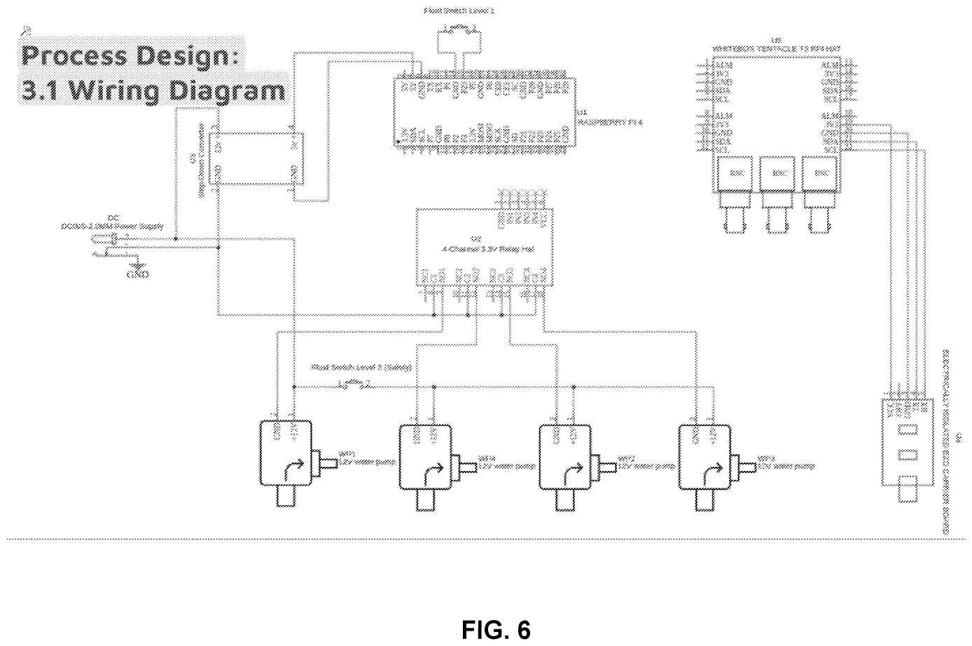

Referring now to FIG. 6, shown is a wiring diagram for the combined dosing and interface unit 320. Relays are used to selectively apply power to pumps for introducing additives, and the relays are controlled by circuitry based on measured variables.

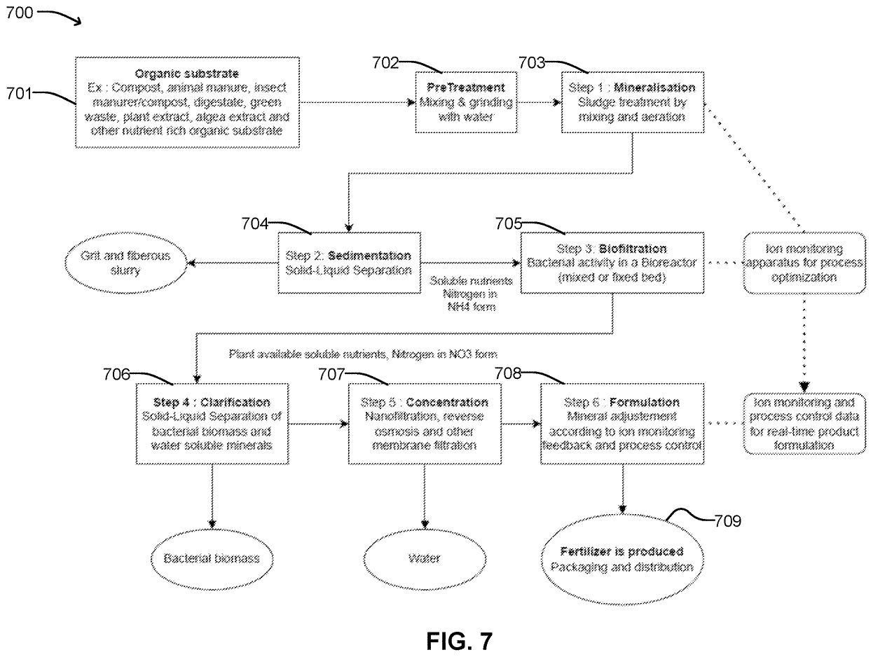

Referring now to FIG. 7, shown is a flowchart of another method 700 of producing an organic fertilizer. The method 700 of FIG. 7 can be executed with use of an organic fertilizer producing apparatus or monitoring apparatus for use in fertilizer production, for example the organic fertilizer producing apparatus 100 of FIG. 1, the monitoring apparatus 300 of FIG. 3, or any other appropriately configured apparatus.

At step 701, the method starts with an input of an organic substrate, for example compost, animal manure, insect manure/compost, digestate, green waste, plant extract, algae extract, agricultural organic waste, etc. At step 702, there is pre-treatment which involves mixing and/or grinding the organic substrate with water.

At step 703, there is mineralisation which involves sludge treatment by mixing and aeration. Oxygen consuming bacteria will degrade organic matter into mineral form, (classically known as aerobic waste water treatment). Instead of going through classical wastewater treatment, the nutrient rich solution is transferred to another bioreactor, which may be referred to as the biofilter.

At step 704, there is sedimentation, which involves separation of solids and liquids. At step 705, there is biofiltration, which involves bacterial activity in an MBBR (Mixed Bed Bio Reactor). Oxygen and alkalinity consuming bacteria convert Ammonia-Nitrogen into Nitrate-Nitrogen, while bacillus can help with phosphorous availability. Here there can be close monitoring of the bacterial reaction rate via measurement of Nitrogen ions variations, and by selecting additives to adjust the pH up or down, alkalinity can be controlled to maintain a coherent ion concentration according to desired output. The use of an MBBR can harness nitrifying bacteria, to control a rate of conversion of NH₄ into NO₃. As described further below with reference to FIGS. 10A and 10B, in some implementations a plurality of variables and ion concentrations are measured in real time to monitor and control the bacterial reaction rate to optimize production of organic fertilizers.

At step 706, there is clarification, which involves solid-liquid separation of bacterial biomass and water soluble minerals. At step 707, there is concentration nanofiltration, which involves reverse osmosis via ceramic membrane filtration.

At step 708, there is formulation, which involves mineral adjustment according to feedback. In some implementations, the mineral adjustment is executed based on data which is gathered from both steps 703 and 705. Note that the mineral adjustment according to feedback can be executed on an ongoing basis, for example two or three weeks, until such time that the organic fertilizer is produced from the bacterial reaction. This can help to enhance the process, reduce nutrient loss, and enhance nutrient mineralization. Thus, it may be possible to ensure target nutrient levels are reached, and balance the organic fertilizer with the right additives. The organic fertilizer can be produced from the organic substrate where nitrogen forms are controlled according to user requirements.

At step 709, after the organic fertilizer is produced, there is packaging and distribution of the fertilizer. The organic fertilizer can be applied like synthetic and mined 18 fertilizer via irrigation systems. The sub-product of the organic fertilizer production is a bacterial biomass and can be used as a biostimulant for soils or biofilter inoculant, for example. In some instances, samples are sent to external laboratories for sample analysis during the process to respect regulations. Initial findings have been within acceptable thresholds.

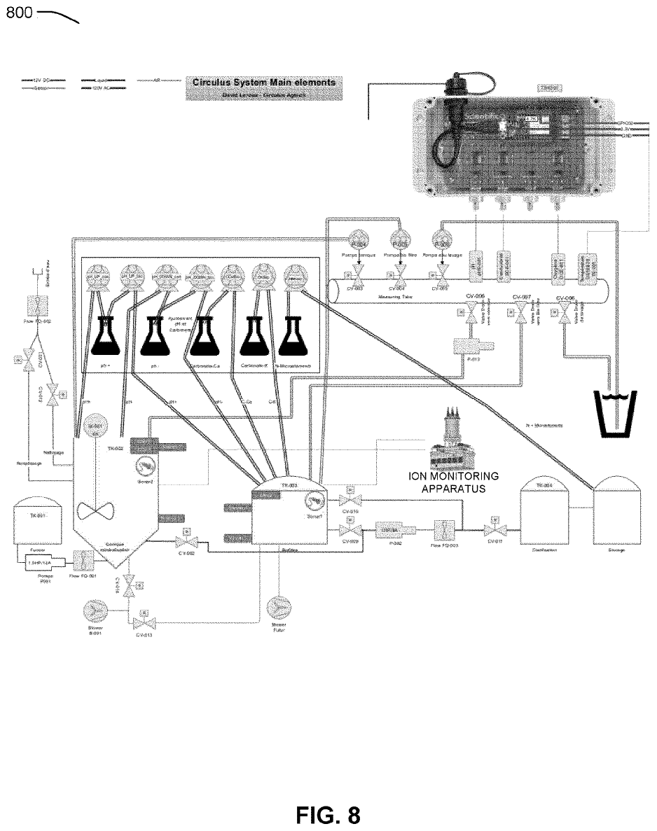

Referring now to FIG. 8, shown is a schematic of another fertilizer producing apparatus 800. This is an overview of the process and the implication of monitoring at specific steps.

Referring now to FIGS. 9A to 9F, shown are schematics of the process for producing the precise fertilizer using the organic substrate.

Referring now to FIGS. 10A and 10B, shown is a flowchart of another method 1000 of producing an organic fertilizer. The method 1000 of FIGS. 10A and 10B can be executed with use of an organic fertilizer producing apparatus or monitoring apparatus for use in fertilizer production, for example the organic fertilizer producing apparatus 100 of FIG. 1, the monitoring apparatus 300 of FIG. 3, or any other appropriately configured apparatus.

At step 1001, the bacterial reaction starts, and at steps 1002, 1003 and 1004 a plurality of variables and ions concentrations are measured. The measurements at steps 1002, 1003 and 1004 may be conducted periodically or continuously in real time throughout the production of the organic fertilizer. In the illustrated example, nitrogen forms (NH₄₊ and NO₃₋) are monitored at step 1002; pH, temperature and dissolved oxygen (DO) are monitored at step 1003; and K+, Ca+ and other ions are monitored at step 1004. At step 1005, the measured ion concentrations are each compared to a target output range. If one or more ions are out of the target range (1005 No output) an initial additive dosage is determined ate step 1006, or if they are within range (1005 Yes output), the ion measurement values are stored.

At step 1008, the measured pH, temperature and DO are each compared to a target range, and if any such parameter out of range (1008 No output), that parameter is adjusted at step 1009, then after a 2 hour delay at step 1010 the parameters are checked again at step 1008. Once the parameters are within target ranges (1008 Yes output), there is a 24 to 72 hour delay at steps 1011 and 1012, and a nitrate-ammonium ratio (NO3-N:NH4-N) is monitored to determine if the ratio is changing at step 1020. If the ratio is not changing after 72 hours (1020 No output, 1012 Yes output), additional bacterial biomass is introduced into the reaction at step 1014.

Once the nitrate-ammonium ratio is changing (1020 Yes output), the rate of change of the ratio is calculated at step 1021 and the method proceeds to step 130 to control the reaction based on the rate of change as discussed further below. Additionally and in parallel, a potassium-calcium ratio is checked at step 1022 and compared to a target range at step 1024. If the potassium-calcium ratio is within the range (1024 Yes output) then no alkaline solutions are added at step 1025 (although alkalinity change may occur and alkalinity increasing solutions may be added later at steps 1044 and/or 1051, as discussed further below). If the potassium-calcium ratio is outside of the range (1024 No output) then a preferred dosage of additives to achieve the desired K+:Ca2+ ratio is calculated at step 1026 and stored at step 1027.

At step 1030, if the rate of change of nitrate-ammonium ratio is greater than one (1030 Yes output), the bacterial reaction rate is stored at step 1039 and the method proceeds to monitor the rate of change at step 1040 on FIG. 10B as discussed below. If the rate of change of nitrate-ammonium ratio is not greater than one (1030 No output), and the ratio itself is greater than 9 (step 1031, Yes output), the method proceeds to step 1060 and the bacterial reaction is stopped as discussed below. If the ratio is not greater than 9 (1031 No output), pH is checked at 1032, and if pH is not over 8 (1032 No output) DO and temperature are adjusted at step 1033, then after a 12 hour delay at step 1034 the method returns to step 1020. If the pH is over 8 (1032 Yes output), then after adjusting DO and temperature at step 1035, pH down is added at 1036 then after a mixing delay at step 1047 the method returns to step 120.

At step 1040, if the rate of change of the nitrate-ammonium ratio is not changing (1040 No output), then at step 1041 if alkalinity is not below 100 ppm CO3 (1041 No output), DO and temperature are adjusted at step 1042, then after a 24 hour delay at step 1043 the method returns to step 1040. If alkalinity is below 100 ppm CO3 (1041 Yes output), alkalinity increasing solutions are added at step 1044 (while maintaining a desired K+:Ca2+ ratio), then the method returns to step 1030. If the rate of change of the nitrate-ammonium ratio is changing (1040 Yes output), pH is checked at step 1045. If pH is not decreasing (1045 No output) If pH is decreasing (1045 Yes output) the method proceeds to step 1050. At step 1050 the nitrate-ammonium ratio is checked, and if not over 9 (1050 No output), the required alkalinity for completion is calculated at step 1051, the potassium-calcium ratio is checked at step 1052, and alkalinity increasing solutions are added at step 1053 (while maintaining a desired K+:Ca2+ ratio) to achieve a pH in the range of 5-6. Then at step 1054 pH increasing solution is added to achieve a pH in the range of 6-7.5, and after a 2 hour delay at step 1055 the method returns to step 1040.

Once the nitrate-ammonium ratio is over 9 (1050 Yes output or 1031 Yes output), the bacterial reaction is stopped at step 1060, then at step 1061 aeration is reduces and a clarifier is run. After a 12 to 72 hour delay at step 1062, the bacterial biomass is harvested at step 1063. After harvesting the bacterial biomass, the clarified liquid is filtered at step 1064 and the organic fertilizer is produced at step 1065. At step 1066 the volume of bacterial biomass is calculated in relation to the stored bacterial reaction rate, and the bacterial biomass production rate is stored at step 1067. At step 1068 portion of the bacterial biomass may be re-introduced into the reaction vessel for producing the next batch of fertilizer.

### Example 1

### Preparation of an Organic Liquid Fertilizer (OLF)

An organic liquid fertilizer (OLF) was prepared using the present method. See FIG. 7. Specifically, pre-treatment (702) consists of grinding the organic substrate and mixing it with water. Step 1 (703) is the aerobic digestion, by mixing and aeration, heterotrophic bacteria initiate organic matter degradation and nutrient release is achieved. Air is pump in the mixture and pH is adjusted to the desired range, ion monitoring is used to establish the peak of nutrient release, calculate initial nutrient ratios and air injection is controlled to avoid gases loses. Step 2 (704) is the mechanical separation, to separate the liquid holding soluble nutrients and un degraded digested solids, sedimentation and screens are used. Step 3 (705) is the biofiltration, where nitrifying bacteria is hosted in a mixed bed bioreactor (MBBR), Nitrogen forms are converted into Nitrates according to a target ratio of N-NO3:N-NH4, K: Ca ratio is used to choose alkalinity additives, to respect the target nutrient content of the desired final fertilizer, pH is controlled with additives in respect of the desired nutrient ratios. Step 4 (706) is the clarification, bacteria produced during the previous step is separated, the volume of free bacteria (not attached to MBBR media) is evaluated, then is either recycled in the MBBR or removed is there is an excess. Step 5 (707) is the concentration steps, the liquid is first filtered with a membrane with pores of 0,1 to 0,25 microns, then water is removed using reverse osmosis, to concentrate the fertilizer. Step 6 (708) is the formulation, according to historical additions of nutrients and the inital nutrient profile of the fertilizer, additives are added to obtain the final fertilizer formulation. Step 7 (709) is the distribution of the product, the fertilizer is stored in containers and shipped to the client, who then either uses it in its farm or repackages the bulk product in smaller formats.

### Example 2

### Results of an Organic Liquid Fertilizer (OLF) on Plant Growth

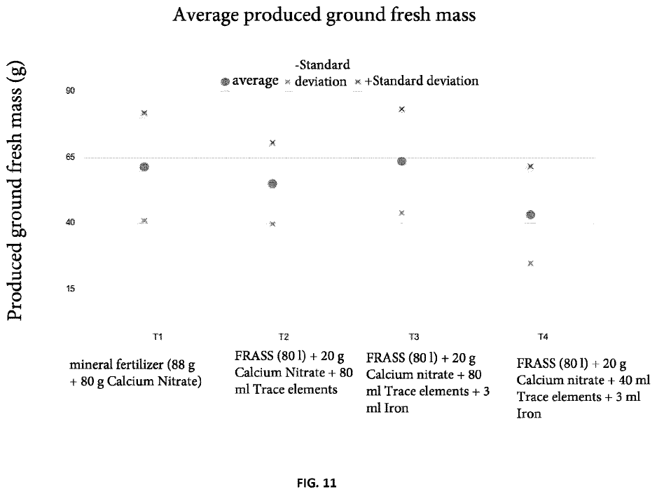

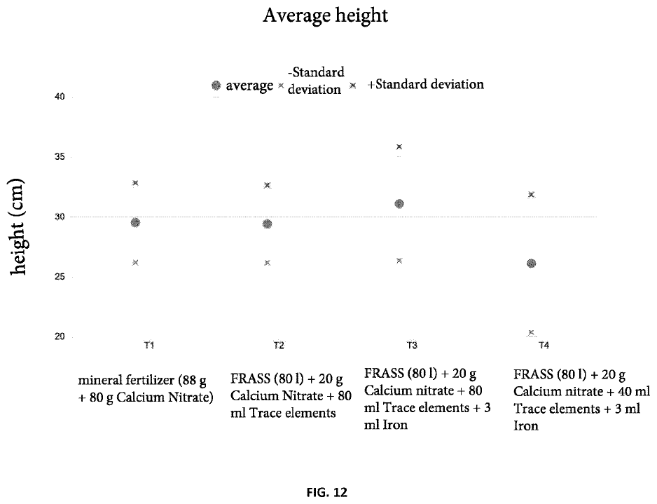

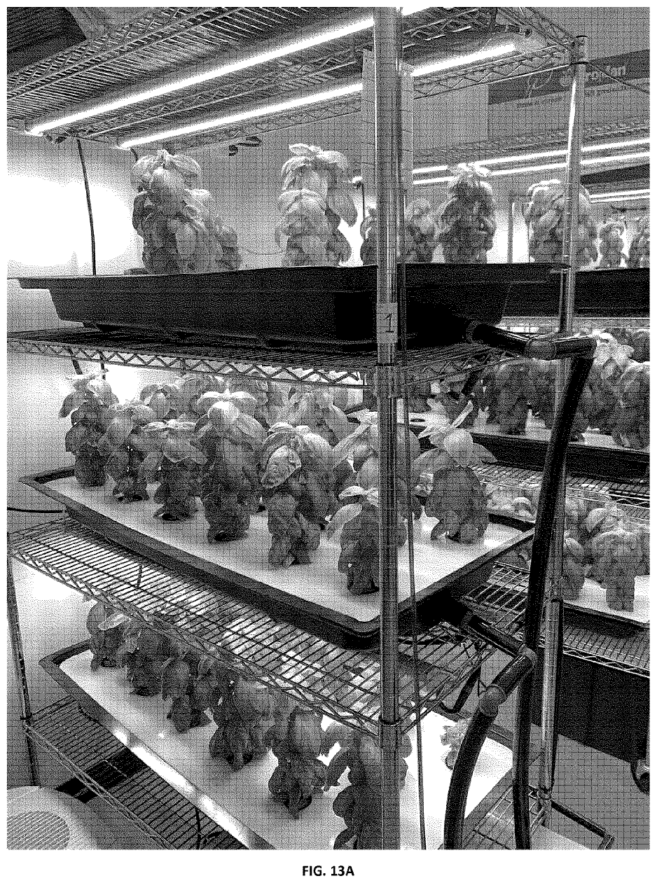

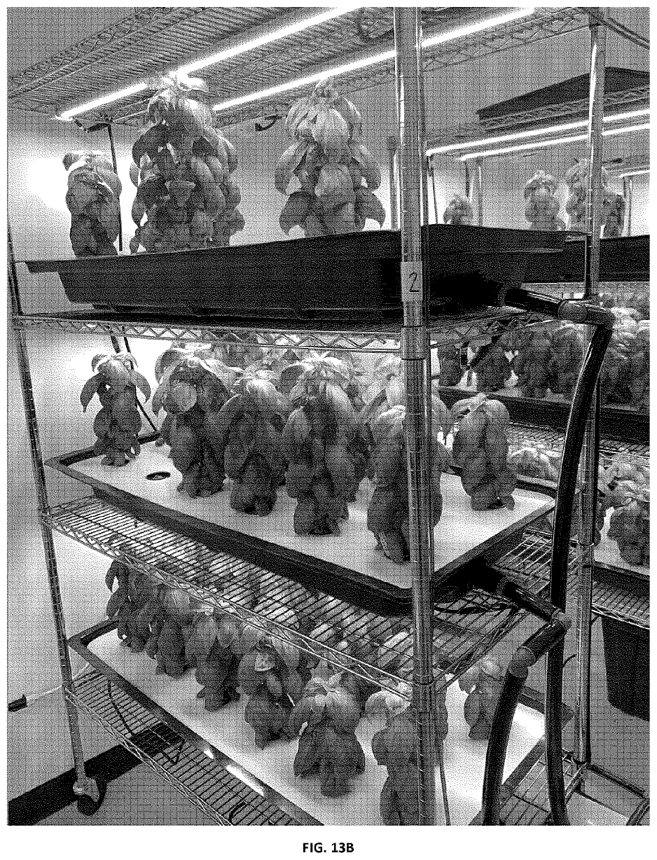

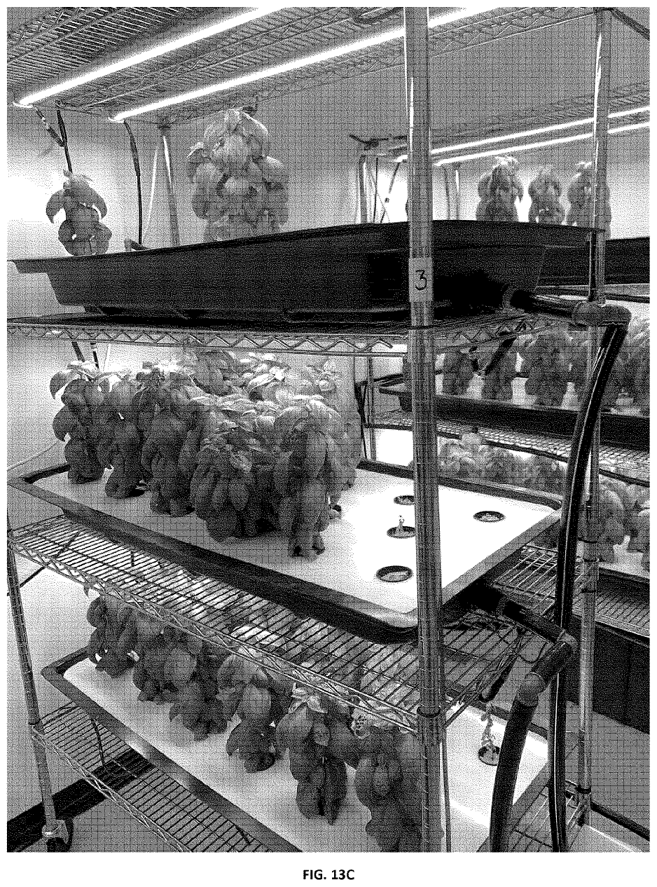

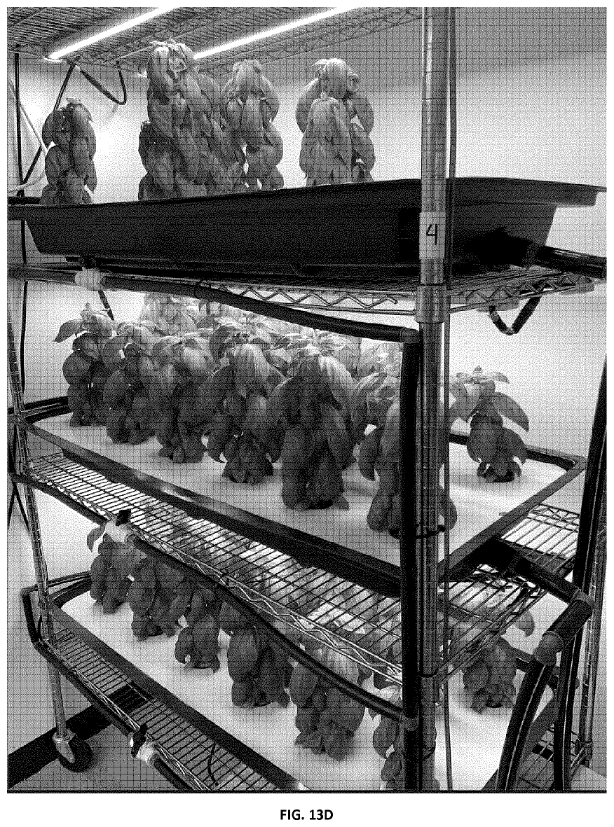

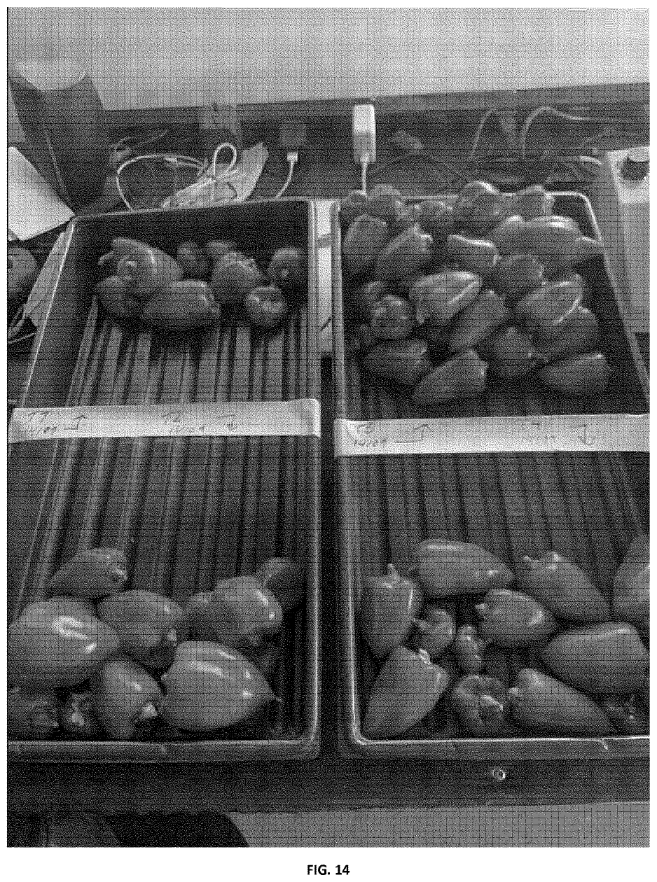

An organic liquid fertilizer (OLF) based on Frass, the manure of tenebrion beetles, was produced using the present method. The OLF was injected in hydroponic production systems where basil plants were grown. The OLF was compared to an inorganic control (Hoagland) solution. A third solution was prepared (OLF+) that combined half-OLF mixed with half inorganic nutrients. In T1, the plants were given mineral fertilizer (88 g+80 g Calcium Nitrate). In T2, the plants were given FRASS (80 I)+20 g Calcium Nitrate+80 ml Trace elements. In T3, the plants were given FRASS (80 I)+20 g Calcium nitrate+80 ml Trace elements+3 ml Iron. In T4, the plants were given FRASS (80 I)+20 g Calcium nitrate+40 ml Trace elements+3 ml Iron. Results for the ground fresh mass produced by the plant are shown in FIG. 11. Results for the average height of the plant are shown in FIG. 12. The T3 test, wherein the plants were given FRASS (80 I)+20 g Calcium nitrate+80 ml Trace elements+3 ml Iron, provided better results for average ground fresh mass produced by the plant and average height of the plant. Photographs of treated basil plants are shown in FIG. 13A to 13D, FIG. 14 and FIG. 15A and FIG. 15B.

### Example 3

### Results of an Organic Liquid Fertilizer (OLF) on Plant Growth

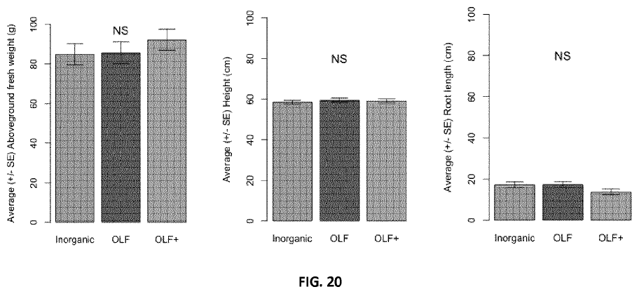

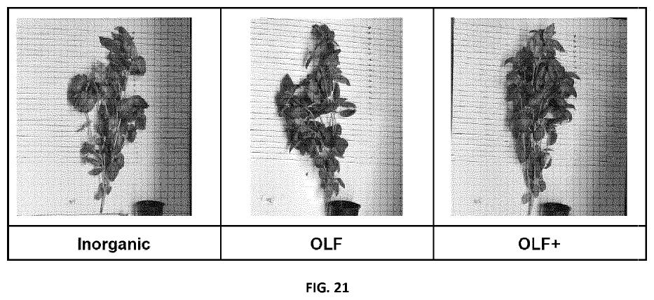

An experiment was conducted to analyze an organic liquid fertilizer (OLF) produced by the present method as an organic substitution of synthetic nitrogen in hydroponics. To test the feasibility of organic substitution of synthetic nitrogen, animal waste from chicken and insects were transformed into a nitrate-rich OLF using a bioreactor system. The OLF was injected into two separate hydroponic basil production systems, including a controlled environment setting and a commercial greenhouse. Yield was compared to an inorganic fertilizer control as well as a 50:50 OLF: inorganic solution (OLF+). Basil plants grown with OLF did not show any significant difference in above ground fresh mass, in height and in root length versus plants grown with inorganic Nitrogen (N) fertilizer in both production systems. Results are shown in FIG. 20 to FIG. 21. As there was no significant difference, OLF produced by the present method could replace inorganic fertilizers in hydroponic systems. Nutrient ion monitoring of the organic solutions according to the present method would allow for optimized formulation of OLF to surpass performance of inorganic fertilizers.

While preferred embodiments have been described above and illustrated in the accompanying drawings, it will be evident to those skilled in the art that modifications may be made without departing from this disclosure. Such modifications are considered as possible variants comprised in the scope of the disclosure.

1. A real-time method of producing an enriched organic fertilizer, comprising:
mixing an organic substrate with water to initiate a bacterial reaction involving the organic substrate;
measuring, in real-time during the bacterial reaction, a plurality of variables concerning the bacterial reaction and concentrations of ions, the ions being at least some of Ca²⁺ (Calcium Ion), K⁺ (Potassium Ion), NH₄⁺ (Ammonium), NO₃₋ (Nitrate), HPO₄²⁻ (Monohydrogen Phosphate), Mg²⁺ (Magnesium Ion), Cl⁻ (Chloride Ion), and Na⁺ (Sodium Ion), wherein each variable and each ion concentration has a defined target;
calculating a nitrate-ammonium ratio and a bacterial rate of change of the nitrate-ammonium ratio;
calculating a potassium-calcium ratio;
regulating the nitrate-ammonium ratio and the bacterial rate of change of the nitrate-ammonium ratio by regulating alkalinity;
regulating alkalinity by selecting an additive according to the potassium-calcium ratio and the ion concentrations and introducing the additive to the bacterial reaction,
upon detecting that any variable of the plurality of variables and ion concentration has deviated from its defined target, introducing an additive into the bacterial reaction until that variable and ion concentration has stopped deviating from its target, thereby regulating all of the variables and ion concentrations according to their defined targets;
wherein the regulating of all of the variables and ion concentrations, the regulating of the nitrate-ammonium ratio and the regulating of alkalinity is executed until each variable and each ion concentration reaches its defined target, the nitrate-ammonium ratio reaches a value of between 7 to 12, and the alkalinity is in the range 50 to 300 meq/L as CaCO₃, and
wherein each ion concentration has a defined target of 100-2500 ppm elemental N for NO₃ (Nitrate) and NH₄⁺ (Ammonium), 30-500 ppm elemental P for HPO₄²⁻ (Monohydrogen Phosphate), 100-3000 ppm for K⁺ (Potassium Ion), 80-1400 ppm for Ca²⁺ (Calcium Ion), 30-700 ppm for Mg²⁺ (Magnesium Ion), less than 750 ppm for Cl⁻ (Chloride Ion).

2. The method of claim 0, wherein the bacterial reaction comprises a mineralization reaction in which the organic substrate is mixed with air to facilitate aerobic digestion, and a biofiltration reaction to improve nutrient availability.

3. The method of claim comprising:
upon detecting that any variable of the plurality of variables has deviated from its defined target, selecting the additive to be introduced from a plurality of candidate additives based on that variable.

4. The method of claim 0, wherein the variables comprise pH (Potential of Hydrogen), the candidate additives comprise a set of pH-reducing additives and a set of pH-increasing additives, and the method comprises:
upon detecting that the pH is higher than its defined target, selecting the additive to be introduced from the set of pH-reducing additives as a function of the ion concentrations; and
upon detecting that the pH is lower than its defined target, selecting the additive to be introduced from the set of pH-increasing additives as a function of the ion concentrations.

5. The method of claim 0, wherein:
the set of pH-reducing additives comprise at least some of H₃PO₄ and H₂SO₄; and
the pH-increasing additives comprise at least some of KOH, Ca(OH)₂, Mg(OH)₂, CaCO₃, K₂CO₃.

6. The method of claim 4, wherein:
selecting the additive to be introduced from the set of pH-reducing additives as a function of the ion concentrations comprises selecting a first pH-reducing additive from the set of pH-reducing additives and selecting a second pH-reducing additive from the set of pH-reducing additives upon detecting that the first pH-reducing additive causes deviation of one of the ion concentrations from its defined target; and
selecting the additive to be introduced from the set of pH-increasing additives as a function of the ion concentrations comprises selecting a first pH-increasing additive from the set of pH-increasing additives and selecting a second pH-increasing additive from the set of pH-increasing additives upon detecting that the first pH-increasing additive causes deviation of one of the ion concentrations from its defined target.

7. The method of claim 4, wherein the defined target for the pH is a target range.

8. The method of claim 4, wherein the target range for the pH varies depending on a stage of the bacterial reaction.

9. The method of claim 1, wherein the target range for each ion concentration is constant during the bacterial reaction.

10. The method of claim 1, wherein:
the set of alkalinity-increasing additives comprise at least some of Ca(OH)2, NaOH, Na₂CO₃, NaHCO₃, Mg(OH)₂, Mg(HCO₃)₂.

11. The method of claim 1, wherein:
selecting the additive to be introduced from the set of alkalinity-increasing additives according to the potassium-calcium ratio and the ion concentrations comprises selecting a first alkalinity-increasing additive from the set of alkalinity-increasing additives and selecting a second alkalinity-increasing additive from the set of alkalinity-increasing additives upon detecting that the first alkalinity-increasing additive causes deviation of one of the ion concentrations from its defined target.

12. The method of claim 0, wherein the variables further comprise EC (Electrical Conductivity) and temperature.

13. The method of claim 0, further comprising:
upon producing the organic fertilizer, measuring additional variables to confirm quality control.

14.-16. (canceled)

17. A monitoring apparatus for producing an organic fertilizer, the monitoring apparatus comprising:
an analyzer having (1) a plurality of probes configured to measure in real-time a plurality of variables concerning a bacterial reaction involving aerobic digestion of an organic substrate that has been mixed with water and concentrations of ions, and (2) a plurality of liquid transfer ports configured to introduce liquids into the bacterial reaction; and
a dosing unit and interface coupled to the analyzer and configured to, upon detecting that any variable of the plurality of variables or any ion has deviated from a defined target, introduce an additive into the bacterial reaction via the liquid transfer ports until that variable has stopped deviating from its target, thereby regulating all of the variables according to their defined targets until the bacterial reaction produces the organic fertilizer.

18. The monitoring apparatus of claim 17, wherein the plurality of probes comprise at least some of a pH (Potential of Hydrogen) probe, a Ca²⁺ (Calcium Ion) probe, a K⁺ (Potassium Ion) probe, an NH₄⁺ (Ammonium) probe, an NO₃₋ (Nitrate) probe, and EC (Electrical Conductivity) probe, and a temperature probe.

19. An organic fertilizer produced using the monitoring apparatus according to claim 17.

20. A non-transitory computer readable medium having recorded thereon statements and instructions that, when executed by a processor of an apparatus, configure the processor to implement the method claim 1.
